(19) United States
(12) Patent Application Publication
(10) Pub. No.: US 2015/0151720 A1
(43) Pub. Date: Jun. 4, 2015

(54) WINDSCREEN WIPER ACTUATION SYSTEM

(71) Applicant: Caterpillar Inc., Peoria, IL (US)

(72) Inventor: Michael J. Wadzinski, Peoria, IL (US)

(73) Assignee: Caterpillar Inc., Peoria, IL (US)

(21) Appl. No.: 14/096,599

(22) Filed: Dec. 4, 2013

(51) Int. Cl. B60S 1/54

(52) U.S. Cl. CPC B60S 1/546

(57) ABSTRACT

An actuation system for a wiper stick of a vehicle is provided for cleaning the windscreen. The actuation system includes a first set of nozzles and a second set of nozzles coupled with a first surface and a second surface of the wiper stick respectively. The second surface is disposed opposite to the first surface. The first set of nozzles and the second set of nozzles may be configured to eject pressurized air on the windscreen. The actuation system further includes a compressor to provide the pressurized air to the first set of nozzles and the second set of nozzles. The actuation system may move the wiper stick on the windscreen by ejecting the pressurized air from the first set of nozzles or the second set of nozzles.

### TECHNICAL FIELD

The present disclosure relates to a windscreen wiping system for a vehicle. More specifically, the present disclosure relates to an actuation system for a windscreen wiper of the vehicle.

### BACKGROUND

Construction or mining machines may operate in rigorous conditions. For example, earth moving machines such as an excavator, an off-highway truck or an agricultural vehicle may operate in dusty and unsafe environment. Hence, typical construction or mining machines are provided with a windscreen to protect the operator from external environment. In addition, the windscreen enables the operator to view the external environment. However, the operation of these machines under varying environments may result in accumulation of debris such as dirt/dust/mud on the windscreen. Also, such machines may operate in rainy or foggy conditions that may cause accumulation of mist on the windscreen. These factors reduce the visibility of the external environment through the windscreen. Low visibility may deteriorate the performance of the operator and may lead to accidents on working sites.

Manual cleaning of the windscreen by the operator may increase the downtime of the machine. Also, in certain scenarios, it may be unsafe for the operator to manually clean the windscreen. Therefore, a wiping system is generally used to clean the windscreen. Such wiping system typically may include one or more wiper sticks having wiper blades which may or may not require fluid to clean the windscreen. The wiper sticks are moved on the windscreen by a hydraulic motor or an electric motor. Further, a cleaning fluid may be sprayed on the windscreen by using a fluid pump. However, in certain scenarios, existing control mechanism of the wiping system may be complex and costly and may be inadequate for cleaning windscreens heavily laden with debris.

### SUMMARY OF THE DISCLOSURE

The present disclosure is directed to an actuation system of a wiper stick for a windscreen of a vehicle. The wiper stick comprises a first surface and a second surface wherein the second surface is disposed opposite to the first surface. The wiper stick is configured to move on the windscreen. The actuation system comprises a first set of nozzles, a second set of nozzles, and a compressor. The first set of nozzles is coupled with the first surface of the wiper stick and is configured to eject a pressurized air. Further, the second set of nozzles is coupled with the second surface of the wiper stick and is configured to eject the pressurized air. Furthermore, the first set of nozzles and the second set of nozzles may move the wiper stick on the windscreen by the ejecting the pressurized air. The compressor is configured to provide the pressurized air to the first set of nozzles and the second set of nozzles.

### BRIEF DESCRIPTION OF DRAWINGS

FIG. 1 illustrates a front view of an exemplary vehicle;

FIG. 2 illustrates a schematic block diagram of an exemplary actuation system for a wiper stick that may be used in conjunction with the vehicle of FIG. 1;

FIG. 3 illustrates a schematic block diagram of the exemplary actuation system for the wiper stick in a first mode of operation; and

FIG. 4 illustrates a schematic block diagram of the exemplary actuation system for the wiper stick in a second mode of operation.

### DETAILED DESCRIPTION OF DRAWINGS

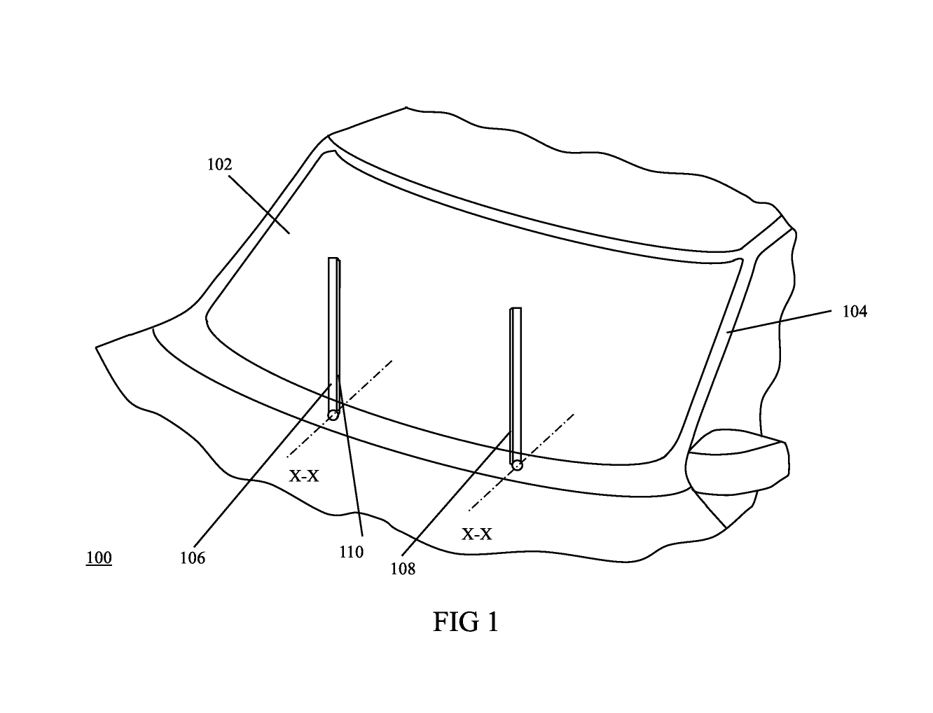

FIG. 1 illustrates a front view of an exemplary vehicle 100 having multiple systems and components that may cooperate to accomplish actuation of a wiper stick. The vehicle 100 may embody a fixed or a mobile machine that performs various operations associated with an industry such as, but not limited to mining, construction, farming, transportation, or automobile industry. For example, the vehicle 100 may be an earth moving machine such as an excavator, a shovel, a backhoe, an automobile or construction machine.

As shown in FIG. 1, the vehicle 100 may comprise a windscreen 102, a frame 104, a wiper stick 106. The windscreen 102 may be mounted on the frame 104 of the vehicle 100. The windscreen 102 can be configured to enable view of external environment to an operator of the vehicle 100. Also, the windscreen 102 may protect the operator of the vehicle 100 from external dust and other harsh conditions. Debris on the windscreen 102 may be cleaned by moving the wiper stick 106 on the surface of the windscreen 102. The wiper stick 106 includes a first surface 108 and a second surface 110 and also includes a wiper blade not shown. The second surface 110 may be disposed opposite to the first surface 108 of the wiper stick 106. Further, the wiper stick 106 may be mounted on the frame 104 and rotate about an axis X-X. In other words, the wiper stick 106 may rotate about the axis X-X sweeping the windscreen 102.

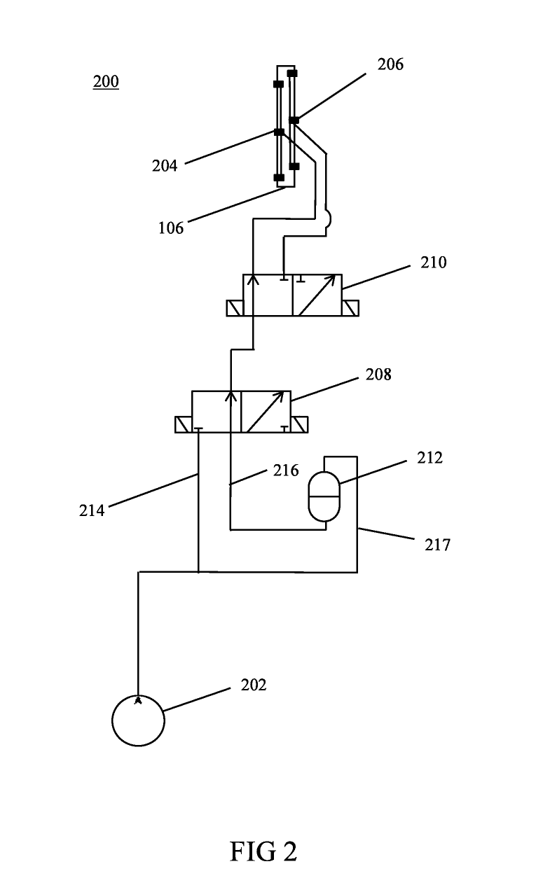

FIG. 2 illustrates an exemplary actuation system 200 that may be used in conjunction with the vehicle 100 of FIG. 1. As shown in FIG. 2, the actuation system 200 may include a compressor 202, a first set of nozzles 204, a second set of nozzles 206, a first control valve 208, a second control valve 210, and a cleaning fluid reservoir 212.

The compressor 202 may supply a pressurized fluid such as air to the first set of nozzles 204 or the second set of nozzles 206 through a line 214, and pressurized air/cleaning fluid through a line 216 in a first embodiment or pressurized cleaning fluid only in a second embodiment.

The first set of nozzles 204 and the second set of nozzles 206 are configured to eject/spray the pressurized air provided by the compressor 202 on the windscreen 102. The first set of nozzles 204 and the second set of nozzles 206 may be coupled to the first surface 108 and the second surface 110 of the wiper stick 106 respectively. The first set of nozzles 204 and the second set of nozzles 206 may be coupled with the wiper stick 106 by welding, fastening or any other coupling mechanism known in the art. For example, the first set of nozzles 204 may be snap fitted on the first surface 108 of the wiper stick 106. Alternatively, the first set of nozzles 204 and the second set of nozzles 206 may be attached in such a way to allow the first set of nozzles 204 and the second set of nozzles 206 to pivot around axes perpendicular and/or tangent to the windscreen 102. This may increase the breadth of the discharge/spray coverage or change the wiper stick 106 angle and/or contact pressure of the wiper stick 106 relative to the windscreen 102. This pivoting action is driven by the thrust of the pressurized air ejected/sprayed from the first set of nozzles 204 and/or the second set of nozzles 206. Similarly, the second set of nozzles 206 may be snap fitted on the second surface 110 of the wiper stick 106. Alternatively, the first set of nozzles 204 and the second set of nozzles 206 may be orifices formed into the first surface 108 and the second surface 110 of the wiper stick 106 respectively. The orifices may comprise a shape such as a venturi that increases the velocity of the fluid ejected or sprayed through the nozzles. The wiper stick 106 moves or sweeps on the surface of the windscreen 102 in a direction opposite to the direction of the ejection/spray of the pressurized air from the first set of nozzles 204. Similarly, the wiper stick 106 may move or sweep on the surface of the windscreen 102 in a direction opposite to the direction of the ejection/spray of the pressurized air from the second set of nozzles 206. In other words, the wiper stick 106 may move on the windscreen 102 due the thrust generated by the pressurized air ejected/sprayed or the fluid ejected/sprayed through the first set of nozzles 204 or the second set of nozzles 206.

The first control valve 208 is a directional control valve that is used to control the flow of pressurized air from, and cleaning fluid as pressurized by, the compressor 202 to the first set of nozzles 204 or the second set of nozzles 206 in a first mode of operation or a second mode of operation. The first control valve 208 is shown, for example, as being a 3 port 2 position directional control valve but could be of any configuration of known valve configurations. The first control valve 208 may provide the pressurized air to the first set of nozzles 204 or the second set of nozzles 206 via the line 214 and the second control valve 210 in the first mode of operation. The first control valve 208 may provide the pressurized air/cleaning fluid to the first set of nozzles 204 or the second set of nozzles 206 via the line 216, the cleaning fluid reservoir 212, and the second control valve 210 in the second mode of operation. In the first mode of operation, only the pressurized air is provided to the first set of nozzles 204 or the second set of nozzles 206. In the second mode of operation, the pressurized air along with a cleaning fluid is provided to the first set of nozzles 204 or the second set of nozzles 206. The cleaning fluid is propelled by the pressurized air when the pressurized air is forced into the cleaning fluid reservoir 212 through a line 217. The cleaning fluid may be ejected/sprayed on the windscreen 102 along with the pressurized air from the first set of nozzles 204 or the second set of nozzles 206. The cleaning fluid is sprayed on the windscreen 102 to remove the dust from the windscreen 102. In other words, the first control valve 208 can either route the pressurized air to the first set of nozzles 204 or the second set of nozzles 206 through the line 214 or the pressurized air along with the cleaning fluid to the first set of nozzles 204 or second set of nozzles 206 through the line 216.

The second control valve 210 is a directional control valve and controls flow of the pressurized air or pressurized air along with the cleaning fluid to the first set of nozzles 204 and the second set of nozzles 206. The second control valve 210 is shown, for example, as being a 3 port 2 positions directional control valve but could be any configuration of known valve configurations. In one position, the second control valve 210 may direct the flow of pressurized air or pressurized air along with the cleaning fluid to the first set of nozzles 204 so as to rotate/move the wiper stick 106 in clockwise direction. In another position, the second control valve 210 may direct the pressurized air or pressurized air along with the cleaning fluid to the second set of nozzles 206 so as to rotate/move the wiper stick 106 in anticlockwise direction.

The first control valve 208 and the second control valve 210 may be an electro-hydraulic valve, an electro-mechanical valve, a hydro-mechanical valve, a hydraulic valve or any other type of valve known in the art. In a certain scenario, the first control valve 208 and the second control valve 210 may be substituted by a single control valve for example 4 port 3 position valve may function in same manner as the first control valve 208 and the second control valve 210. Further, it may be appreciated that any number of valves can be used to provide the similar functionality.

The cleaning fluid reservoir 212 may include cleaning fluid suitable for cleaning the windscreen 102. In an embodiment, the cleaning fluid reservoir 212 may be an accumulator, a pressurized vessel etc. In this scenario, when the cleaning fluid reservoir 212 is a pressurized vessel charged with compressed gas delivered from the compressor 202 through line 217, the pressurized vessel may provide pressurized cleaning fluid to the first set of nozzles 204 or the second set of nozzles 206 through line 216 and the first control valve 208. In this scenario, the wiper stick 106 may move on the windscreen 102 due to the thrust generated by the pressurized cleaning fluid ejected/sprayed from the first set of nozzles 204 or the second set of nozzles 206.

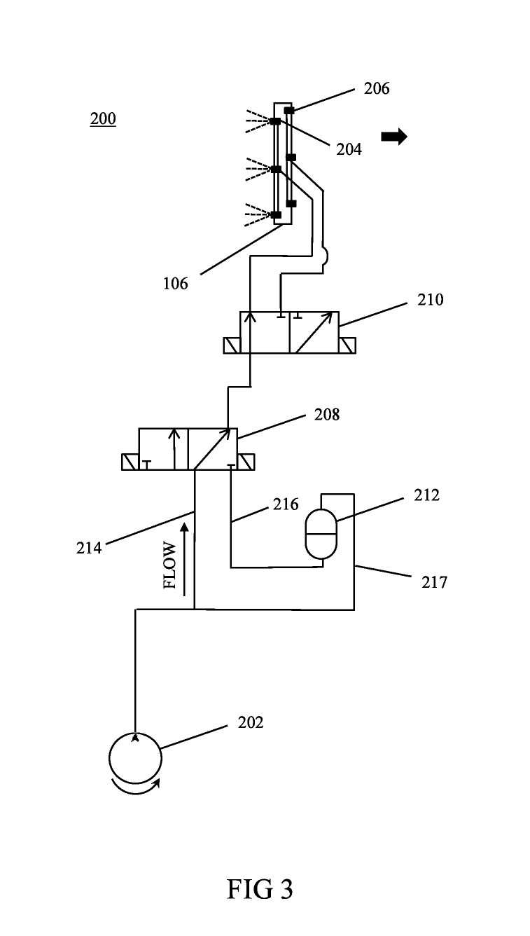

FIG. 3 illustrates the schematic block diagram of the exemplary actuation system 200 in the first mode of operation. The first mode of operation may include ejecting/spraying only the pressurized air on the surface of the windscreen 102. In the first mode of operation, the first control valve 208 may be operated in a position (as shown in FIG. 3) so as to provide the pressurized air to the first set of nozzles 204 or the second set of nozzles 206 via the line 214 and the second control valve 210. As shown in FIG. 3, the second control valve 210 is operated in a first position to eject the pressurized air from the first set of nozzles 204. However, it may be appreciated that the second control valve 210 may also be operated in a second position to eject the pressurized air from the second set of nozzles 206. The first set of nozzles 204 may eject/spray the pressurized air at a high velocity in a first direction (as indicated in FIG. 3). The ejection/spraying of the pressurized air may move the wiper stick 106 on the surface of windscreen 102 in a direction opposite to the first direction. The direction of the movement of the wiper stick 106 is indicated by the arrow in FIG. 3. The wiper stick 106 moves on the windscreen 102 due the thrust generated by the pressurized air sprayed/ejected from the first set of nozzles 204. Similarly, the wiper stick 106 may move on the surface of windscreen 102 by ejecting the pressurized air from the second set of nozzles 206.

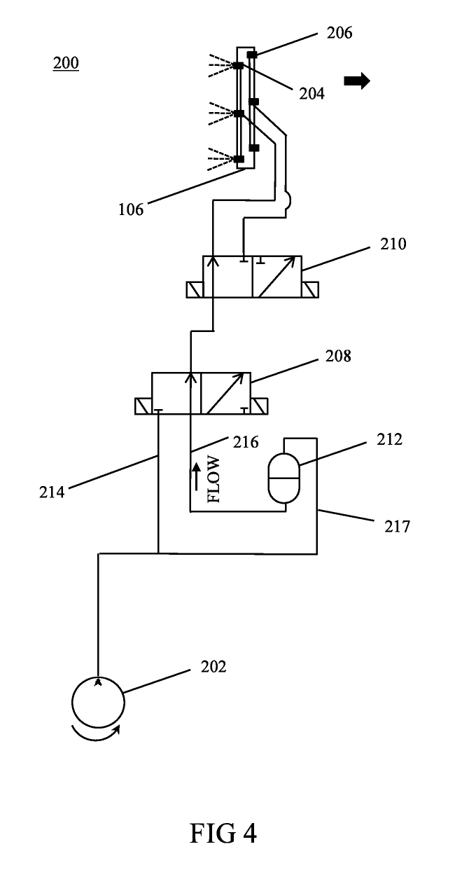

FIG. 4 illustrates the schematic block diagram of the exemplary actuation system 200 in the second mode of operation. The second mode of operation may include ejecting/spraying the pressurized air along with the cleaning fluid on the windscreen 102. In the second mode of operation, the first control valve 208 may be operated in a position (as shown in FIG. 4) to provide the pressurized air to the first set of nozzles 204 or the second set of nozzles via the line 216, and the cleaning fluid reservoir 212. As shown in FIG. 4, the second control valve 210 is operated in the first position to eject the pressurized air along with the cleaning fluid from the first set of nozzles 204. However, it may be appreciated that the second control valve 210 may also be operated in the second position to eject the pressurized air along with the cleaning fluid from the second set of nozzles 206. The cleaning fluid may be propelled by the pressurized air as when the pressurized air from the compressor 202 is forced into the cleaning fluid reservoir 212 through line 217. In a second embodiment the fluid reservoir 212 may be open to atmospheric pressure and cleaning fluid may be drawn into fluid line 216 as by atomization. In this manner it may be contemplated that the cleaning fluid may be mixed with the pressurized air. The pressurized air/cleaning fluid is sprayed on the windscreen 102 to remove the dust from the windscreen 102.

The first set of nozzles 204 may eject/spray the pressurized air along with the cleaning fluid at a high velocity in the first direction (as indicated in FIG. 4). The ejection/spraying of the pressurized air along with the cleaning fluid may move the wiper stick 106 on the surface of windscreen 102 in a direction opposite to the first direction. The direction of the movement of the wiper stick 106 is indicated by the arrow in FIG. 4. The wiper stick 106 moves in a clockwise direction on the windscreen 102 due the thrust generated by the pressurized air sprayed/ejected from the first set of nozzles 204. Similarly, the wiper stick 106 may be moved on the surface of windscreen 102 in the anti-clockwise direction by ejecting the pressurized air along with cleaning fluid from the second set of nozzles 206.

The second control valve 210 may switch between the clockwise and the anti-clockwise movement of the wiper stick 106, each in the first mode and the second mode by switching between the first set of nozzles 204 and second set of nozzles 206.

Further, it may be appreciated that the actuation system 200 may include additional components, such as filters relief valves, check valves, etc. However, it is understood to a person ordinarily skilled in the art that additional components nowhere effects or limits the functionality of the present disclosure.

### INDUSTRIAL APPLICABILITY

The vehicle 100 may operate in a dirty/dusty environment. The operation of the vehicle 100 under dusty environment may result in accumulation of dirt/dust/mud on the windscreen 102. The dirty windscreen may result in low visibility of the external environments for the operator. Therefore, the wiper stick 106 is moved on the windscreen 102 to clean the windscreen 102. A cleaning fluid may also be sprayed on the windscreen 102 to remove the dust from the windscreen 102. The wiper stick 106 is moved on the windscreen 102 by the actuation system 200. The actuation system 200 may include the compressor 202, the first set of nozzles 204, the second set of nozzles 206, the first control valve 208, the second control valve 210, and the cleaning fluid reservoir 212.

The actuation system 200 may operate the wiper stick 106 in first mode or a second mode. When the operator commands the first mode of operation, the first control valve 208 is operated in the first position (as shown in FIG. 3). This allows only the pressurized air from the compressor 202 is sprayed/ejected from the first set of nozzles 204 or the second set of nozzles 206 on the windscreen 102. The wiper stick 106 moves on the surface of the windscreen 102 in a direction opposite to the direction of spray of the pressurized air. The wiper stick 106 moves on the surface of the windscreen 102 due to the thrust generated by the ejected pressurized air. A controller (not shown in FIG) may control the direction of movement of the wiper stick 106 by actuating the second control valve 210. For example, when the controller operates the second control valve 210 in a first position, the pressurized air is ejected from the first set of nozzles 204. The ejection of the pressurized air from the first set of nozzles 204 moves the wiper stick 106 in the clockwise direction on the surface of the windscreen 102. Similarly, when the controller operates the second control valve 210 in a second position, the pressurized air is ejected from the second set of nozzles 206. The ejection of the pressurized air from the second set of nozzles 206 moves the wiper stick 106 on the surface of the windscreen 102 in the anti-clockwise direction.

When the operator commands the second mode of operation, the first control valve 208 may be operated in the second position (as shown in FIG. 4). This allows the pressurized air from the compressor 202 along with the cleaning fluid from the cleaning fluid reservoir 212 is sprayed/ejected from the first set of nozzles 204 or the second set of nozzles 206 on the windscreen 102. The cleaning fluid is sprayed on the windscreen 102 to help removal of the dust from the windscreen 102. The wiper stick 106 moves on the surface of the windscreen 102 in a direction opposite to the direction of spray of the pressurized air. The wiper stick 106 moves on the surface of the windscreen 102 due to the thrust generated by the ejected pressurized air. A controller (not shown in FIG) may control the direction of movement of the wiper stick 106 by actuating the second control valve 210 in any one of the two positions.

The first mode of operation and the second mode of operation may either be activated manually by an operator or automatically based on the inputs from various sensors, such as rain sensor. Further, the first mode of operation and the second mode of operation may be started sequentially in one complete cycle of movement of the wiper stick 106. A controller (not shown in FIGs) may be configured to control the operation of the wiper stick 106 in the first mode or operation and/or the second mode of operation. For example, when an operator commands the wiper stick 106 to move on the windscreen 102, a controller (not shown in FIGs) may trigger the movement of the wiper stick 106 on the windscreen 102 in a second mode. In other words, the wiper stick 106 may sweep the windscreen 102 in a clockwise direction from a first position to a second position by spraying the pressurized air along with the cleaning fluid from the first set of nozzles 204 on the windscreen 102. Thereafter, the controller may trigger the movement of the wiper stick 106 from the second position to the first position by driving the wiper stick 106 in a first mode. In other words, the wiper stick 106 may sweep the windscreen 102 in anti-clockwise direction from the second position to the first position by spraying the pressurized air from the second set of nozzles 206 on the windscreen 102. Therefore, the windscreen 102 of the vehicle 100 is cleaned from the dust and cleared of any residual cleaning fluid or moisture.

In a scenario such as during rainy condition, there may not be a need of spraying the cleaning fluid on the windscreen 102. In this scenario, the operator or controller may command the wiper stick 106 to move only in the first mode of operation. Hence, the wiper stick 106 is moved on the windscreen 102 in clockwise direction by ejecting or spraying the pressurized air from the first set of nozzles 204. The wiper stick 106 is moved on the windscreen 102 in anti-clockwise direction by ejecting or spraying the pressurized air from the second set of nozzles 206. The direction of movement of wiper stick 106 is changed by controlling the second control valve 210. In one position, the second control valve 210 may direct the flow of pressurized flow to the first set of nozzles 204 so as to rotate or move the wiper stick 106 in clockwise direction. In another position, the second control valve 210 may direct the pressurized air to the second set of nozzles 206 so as to rotate the wiper stick 106 in anti-clockwise direction. Therefore, actuation system 200 may move the wiper stick 106 on the windscreen 102 to wipe the windscreen 102.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim

What is claimed is:

1. An actuation system for a wiper stick of a windscreen for a vehicle, the wiper stick comprising a first surface and a second surface disposed opposite to the first surface, the wiper stick is configured to move on the windscreen, the actuation system comprising:
a first set of nozzles coupled to the first surface of the wiper stick and configured to eject a pressurized air;
a second set of nozzles coupled to the second surface of the wiper stick and configured to eject pressurized air;
a compressor configured to provide the pressurized air to the first set of nozzle and the second set of nozzles; and
wherein the first set of nozzles and the second set of nozzles are configured to move the wiper stick on the windscreen by ejecting the pressurized air.
